(19) United States
(12) Patent Application Publication
(10) Pub. No.: US 2005/0168346 A1
(43) Pub. Date: Aug. 4, 2005

(54) Flashing wheel cover

(76) Inventor: Li Yue Huang Tsai, Tainan City (TW)

Correspondence Address: HUANG TSAI LI YUE, P.O. Box 90, Tainan City, 704, TW

(21) Appl. No.: 10/774,949

(22) Filed: Feb. 4, 2004

(51) Int. Cl. G08B 5/22

(52) U.S. Cl. 340/815.45; 340/425.5

(57) ABSTRACT

A flashing wheel cover comprises a cover having a plurality of via holes; a box body at an inner surface of the cover; the box body being formed with a seat, a permeation-proof washer, and a cover body; the seat and cover body being transparent; a wall of the seat having a plurality of convex cambered surfaces; the permeation-proof washer being installed between the seat and the cover body; a circuit board being installed in the box body; the circuit board being installed with a plurality of LEDs, a light controlled IC, and a plurality of batteries, a vibration switch and an LED IC. The flashing way of the LEDs is controlled by the LED IC so as to present various flashing way. The wheel speed increases, an apparent flash circle is presented so as to present a beautiful effect and alert other peoples to take attention to the cars.

### BACKGROUND OF THE INVENTION

1. Field of the Invention

The present invention relates to a flashing wheel cover, wherein the flashing way of the LEDs is controlled by an LED IC so as to present various flashing way. When the wheel rotates, an apparent flash circle is presented so as to present a beautiful effect and alert other peoples to take attention to the cars.

2. Description of the Prior Art

In the prior art, wheel covers of cars are made of various shapes, or are formed with various textures or painted with various colors so as to present a beautiful outlook. However, these variations cannot satisfy the requirement of people. Thereby, to further have a prefect effect, some people adhere colored illuminating sheets on the wheel cover so that when the car drive at night, the wheel cover will present a flash effect to users. However, the flash sheet is easy to drop out or scratched. This is not a preferred way and thus there is a demand for a novel design which can improve the defect in the prior art.

### SUMMARY OF THE INVENTION

Accordingly, the primary object of the present invention is to provide a flashing wheel cover, wherein the flashing way of the LEDs is controlled by the LED IC so as to present various flashing ways. When the wheel speed increases, an apparent flash circle is presented so as to present a beautiful effect and alert other peoples to take attention to the cars.

To achieve above objects, the present invention provides a flashing wheel cover which comprises a cover formed with a plurality of via holes; a box body at an inner surface of the cover; the box body being formed with a seat, a permeation-proof washer, and a cover body; the seat and cover body being transparent; a wall of the seat being formed with a plurality of convex cambered surfaces; the permeation-proof washer being installed between the seat and the cover body; a circuit board being installed in the box body; the circuit board being installed with a plurality of LEDs, a light controlled IC, and a plurality of batteries, a vibration switch and an LED IC. In assembly, the circuit board is installed in the seat of the box body so that the LEDs and light controlled IC are aligned to the convex cambered surfaces of the seat; and the cover body covers the seat. The cover body is assembled in the inner surface of the wheel cover. Each convex cambered surfaces of the seat is positioned on a respective via hole of the cover; and the bottom of the seat fixes the box body to the inner surface of the cover.

The various objects and advantages of the present invention will be more readily understood from the following detailed description when read in conjunction with the appended drawing.

### BRIEF DESCRIPTION OF DRAWINGS

FIG. 1 is an exploded perspective view of the present invention.

FIG. 2 is an assembled perspective view of the present invention.

FIG. 3 is an assembled cross section view of the present invention.

FIG. 4 is a schematic view of the present invention.

FIG. 5 is a flow diagram of the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

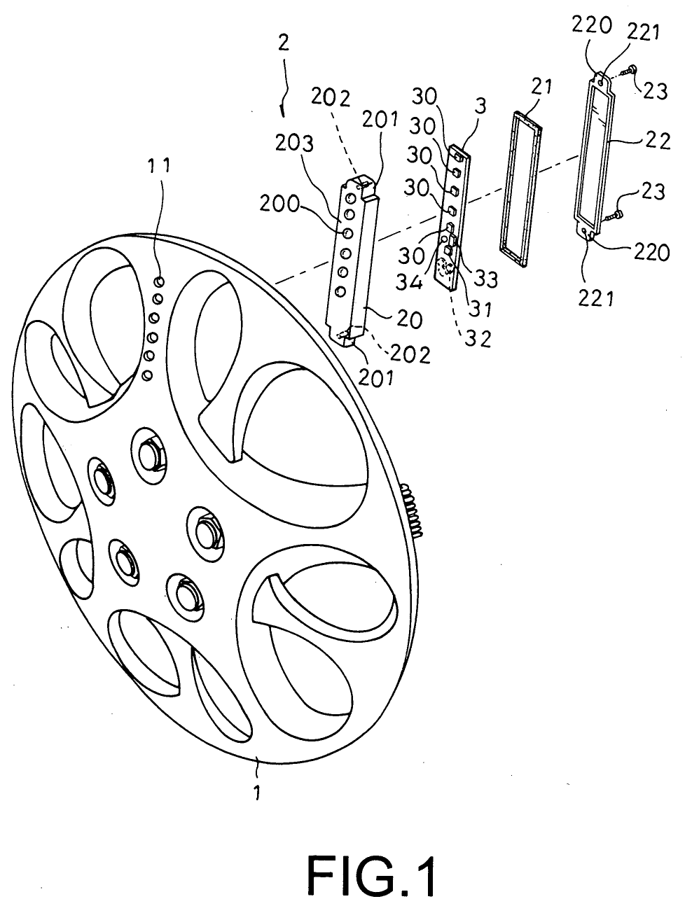

With reference to FIG. 1, the flashing wheel cover of the present invention is illustrated. The flashing wheel cover comprises a cover 1, a plurality of via holes 11. A box body 2 is installed at an inner surface of the cover 1. The box body 2 is formed with a seat 20, a permeation-proof washer 21, and a cover body 22. The seat 20 and cover body 22 are transparent. A wall of the seat 20 is formed with a plurality of convex cambered surfaces 200. Two ends of the seat 20 have ears 201. Each ear 201 has a through hole 202. One side of the seat 20 is a rubber surface 203. The permeation-proof washer 21 is installed between the seat 20 and the cover body 22. Two sides of the cover body 22 have respective ears 220. Each ear 220 has a through hole 221. Screws 23 pass through the through holes 220 and 202. A circuit board 3 is installed in the box body 2. The circuit board 3 is installed with a plurality of LEDs 30, a light controlled IC 31, and a plurality of batteries 32, a vibration switch 33 and an LED IC.

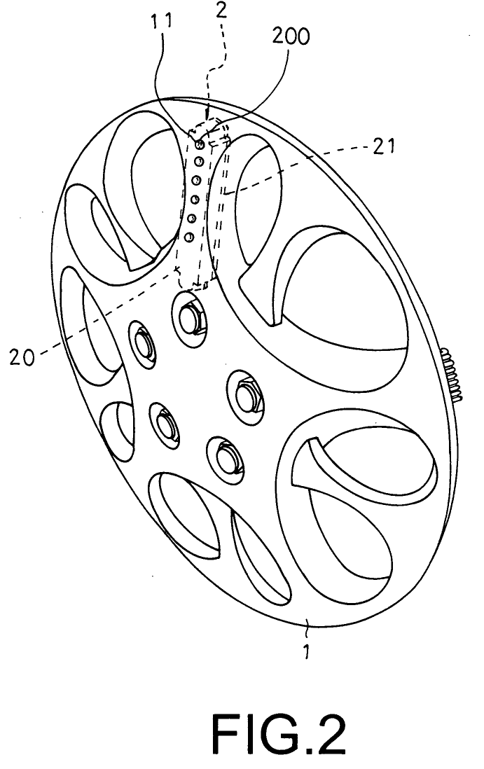

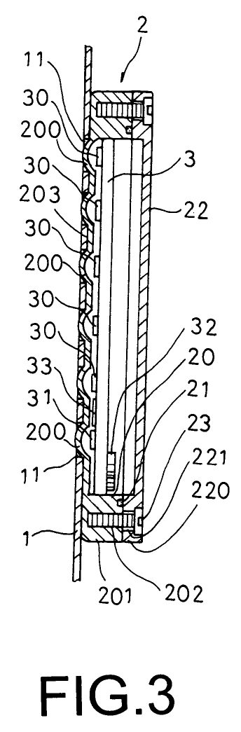

In assembly, as shown in FIGS. 1, 2 and 3, the circuit board 3 is installed in the seat 20 of the box body 2 so that the LEDs 30 and light controlled IC 31 are aligned to the convex cambered surfaces 200 of the seat 20. The permeation-proof washer 21 is installed on the seat 20. Then the cover body 22 covers the seat 20. The screws serve to fix the cover body 22 and the seat 20. Then the cover body 2 is assembled in the inner surface of the wheel cover 1. Each convex cambered surfaces 200 of the seat 20 is positioned on a respective via hole 11 of the cover 1. By the rubber surface 203 on the bottom of the seat 20, the box body 2 is fixed to the inner surface of the cover 1. The assembly is rapid and convenient.

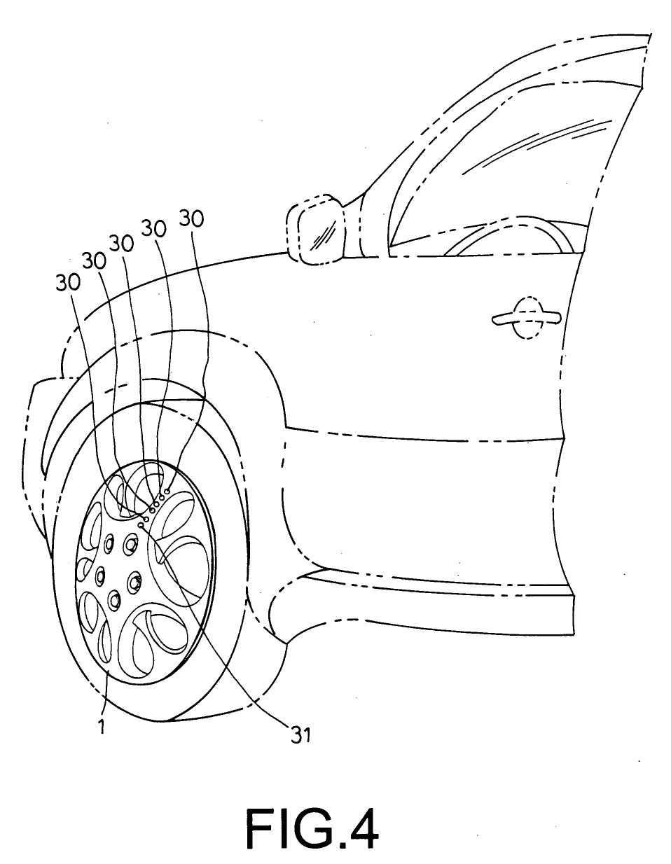

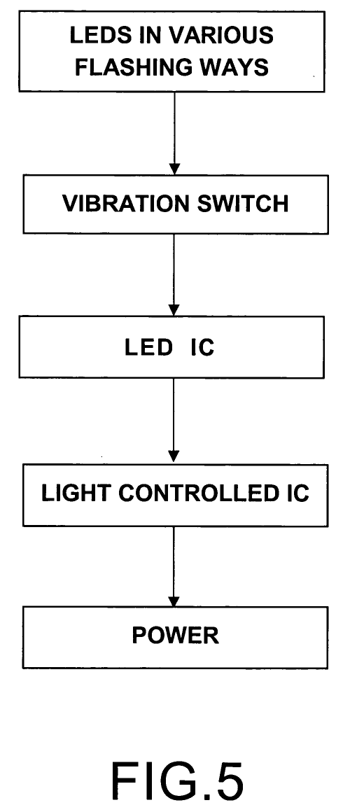

In use, as shown in FIGS. 4 and 5, the wheel cover 1 is embedded into a wheel frame. When driving in night, the light controlled IC 31 on the circuit board 3 is sensed through the via holes 11 in the cover 1. The sensing signals are transferred to the circuit board 3. Power in the circuit board 3 is conducted. When a car drives on a road, the wheel will vibrate due to the rotation of the wheel, the vibration switch 33 on the circuit board 3 will turn on and the LED IC 34 is actuated so that the LEDs light up. The light from the LEDs 30 emits out from the via holes 11 of the wheel cover 1 and the convex cambered surfaces 200 of the seat 20. When driving at night, the LEDs on the cover 1 lights up due to both of the rotation and vibration of the wheel. The flashing way of the LEDs is controlled by the LED IC 34 so as to present various flashing way. When the wheel speed increases, a flash circle is presented clearly so as to present a beautiful effect and alert other peoples to take attention to the cars.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A flashing wheel cover comprising:
a cover having a plurality of via holes;
a box body at an inner surface of the cover; the box body being formed with a seat, a permeation-proof washer, and a cover body; the seat and cover body being transparent; a wall of the seat being formed with a plurality of convex cambered surfaces; the permeation-proof washer being installed between the seat and the cover body;
a circuit board being installed in the box body; the circuit board being installed with a plurality of LEDs, a light controlled IC, and a plurality of batteries, a vibration switch and an LED IC;
wherein in assembly, the circuit board is installed in the seat of the box body so that the LEDs and light controlled IC are aligned to the convex cambered surfaces of the seat; the permeation-proof washer is installed on the seat; then the cover body covers the seat; screws are used to fix the cover body and the seat; then the cover body is assembled in an inner surface of the wheel cover; each convex cambered surfaces of the seat is positioned on a respective via hole of the cover; and the bottom of the seat fixes the box body to the inner surface of the cover.

2. The flashing wheel cover as claimed in claim 1, wherein two ends of the seat have respective ears; each ear of the seat has a through hole; and one side of the seat is a rubber surface; two sides of the cover body have respective ears; each ear of the cover body has a respective through hole; and screws pass through the through holes of ears of the seat and the cover body.

3. The flashing wheel cover as claimed in claim 1, wherein one side of the seat is a rubber surface.
